(19) United States
(12) Patent Application Publication
(10) Pub. No.: US 2011/0081951 A1
(43) Pub. Date: Apr. 7, 2011

(54) APPARATUS AND METHOD FOR SETTING MAIN SIM CARD IN DUAL SIM CARD TERMINALS

(75) Inventor: Sun-Ho HWANG, Seoul (KR)

(73) Assignee: SAMSUNG ELECTRONICS CO. LTD., Suwon-si (KR)

(21) Appl. No.: 12/898,978

(22) Filed: Oct. 6, 2010

(30) Foreign Application Priority Data
Oct. 7, 2009 (KR) 10-2009-0094956

(51) Int. Cl. H04B 1/38

(52) U.S. Cl. 455/558

(57) ABSTRACT

An apparatus and a method for setting a main Subscriber Identity Module (SIM) card in a multiple SIM card terminal are provided. The method includes displaying a segmented setting item according to a service type per each SIM card when a main SIM card setting menu is selected, and setting a SIM card selected per the service type as a main SIM card for the corresponding service type when one SIM card per each service type is selected.

PRIORITY

This application claims the benefit under 35 U.S.C. §119(e) of a Korean patent application filed in the Korean Intellectual Property Office on Oct. 7, 2009 and assigned Serial No. 10-2009-0094956, the entire disclosure of which is hereby incorporated by reference.

### BACKGROUND OF THE INVENTION

1. Field of the Invention

The present invention relates to a dual Subscriber Identity Module (SIM) card terminal. More particularly, the present invention relates to an apparatus and a method for setting a main SIM card in dual SIM card terminals.

2. Description of the Related Art

A Subscriber Identity Module (SIM) card is used with a mobile terminal to store personal information for the provision of various services such as subscriber authentication, charging and security functions, and the like. The SIM card has been developed in order for a user to use mobile communication conveniently in the user's telephone in any region without regard to mobile communication technology standards, for example, Code Division Multiple Access (CDMA) or Global System for Mobile Communication (GSM).

The SIM card may be manufactured as a smart card that is insertable in a mobile terminal. A mobile terminal inserted with the SIM card performs an initialization process containing an authentication process by reading subscriber information stored in the SIM card upon booting. In addition, the mobile terminal may only be usable with an authenticated SIM card.

Generally, a mobile terminal capable of using one SIM card has been employed, but recently a mobile terminal that may be used with a combination of two SIM cards (hereinafter, referred to as ‘dual SIM card terminal’) has been introduced. The dual SIM card terminal may be used by combining SIM cards of two different providers or a same provider, so that a user may use two telephone numbers with one mobile terminal. As such, in a case where two SIM cards are combined, the two SIM cards may be distinguished as a main SIM card and a secondary SIM card according to user settings, and overall mobile communication services may be provided through the main SIM card set by a user. As such, a combination of two SIM cards for use may attribute to a different service charging system per each provider/region or a different usage for each SIM card (for example, for business/personal). Thus, a user may utilize a SIM card consistent with the user's objective by changing settings for a main SIM card and a secondary SIM card.

FIG. 1 is a diagram showing a SIM card management menu for setting a main SIM card and a secondary SIM card in a dual SIM card terminal according to the related art. A user may establish a main SIM card and a secondary SIM card by selecting a setting item for two SIM cards through a SIM card management menu. For example, the setting item may include an enable item indicating whether the corresponding SIM card is to be enabled or a default item indicating whether a corresponding SIM card is used as a default over entire mobile communication service. As shown in FIG. 1, the user enables SIM card ‘A’ and SIM card ‘B’ by selecting the enable items associated therewith. Also, the user sets SIM card ‘A’ as a main SIM card by selecting the default item associated therewith, and sets SIM card ‘B’ as a secondary SIM card by not selecting the default item associated therewith. In other words, the user selects an enable item and a default item corresponding to SIM card ‘A’, and only selects a corresponding enable item for SIM card ‘B’.

As such, a user may select and set only one SIM card for the provision of mobile communication services through a SIM card management menu. However, when only one SIM card is set for providing the mobile communication service, there exists a problem that a user should alter the settings of the SIM cards manually through a direct menu manipulation whenever the user desires to use a corresponding service associated with the other SIM card.

Therefore, a need exists for an improved apparatus and a method for setting a main SIM card in a dual SIM card terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for setting a main Subscriber Identity Module (SIM) card in a dual SIM card terminal.

Another aspect of the present invention is to provide an apparatus and a method for switching a SIM card on at least one of an application-specific basis, a service-specific basis, a location-specific basis, a region-specific basis, and a provider-specific basis.

Another aspect of the present invention is to provide an apparatus and a method for setting a main SIM card according to at least one of an application-specific basis and a service-specific basis in a dual SIM card terminal by segmenting setting items for two SIM cards in a SIM card management menu.

Another aspect of the present invention is to provide an apparatus and a method for setting a main SIM card according to at least one of a location-specific basis, a region-specific basis, and a provider-specific basis in a dual SIM card terminal by segmenting setting items for two SIM cards in a SIM card management menu.

Another aspect of the present invention is to provide an apparatus and a method for switching a current SIM card to a main SIM card corresponding to at least one of an execution-requested application, and an execution-requested service automatically in a dual SIM card terminal by consulting SIM card setting information when the corresponding at least one of the application and the service execution is requested.

Another aspect of the present invention is to provide an apparatus and a method for switching a current SIM card to a main SIM card corresponding to an adjusted at least one of a location, a region, and a provider automatically in a dual SIM card terminal by obtaining a corresponding at least one of location, region, and provider information automatically, and recognizing a change in the corresponding at least one of location, region, and provider and consulting SIM card setting information while a user is mobile.

According to an aspect of the present invention, a method of setting a main SIM card in a multiple SIM card terminal is provided. The method includes displaying a segmented setting item according to a service type per each SIM card in a case a main SIM card setting menu is selected, and setting a selected SIM card for a service type as a main SIM card for the corresponding service type when one SIM card per each service type is selected.

According to another aspect of the present invention, an apparatus for setting a main SIM card in a multiple SIM card terminal is provided. The apparatus includes a control unit for controlling to display a segmented setting item according to a service type per each SIM card on a display unit when a main SIM card setting menu is selected and for setting a selected SIM card for the service type as a main SIM card for the corresponding service type when one SIM card per each service type is selected through an input unit, the display unit for displaying the segmented setting item according to the service type per each SIM card, and the input unit for receiving the selection of one SIM card per each service.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram showing a Subscriber Identity Module (SIM) card management menu for a main SIM card and a secondary SIM card in a dual SIM card terminal according to the related art;

FIG. 2 is a diagram showing a construction of a dual SIM card terminal according to an exemplary embodiment of the present invention;

FIG. 3 is a diagram showing a SIM card management menu for setting a main SIM card based on at least one of an application-specific basis and a service-specific basis in a dual SIM card terminal by segmenting setting items for two SIM cards in a SIM card management menu according to an exemplary embodiment of the present invention;

FIG. 4 is a flowchart showing a method for setting a main SIM card based on at least one of an application-specific basis and a service-specific basis in a dual SIM card terminal by segmenting setting items for two SIM cards in a SIM card management menu according to an exemplary embodiment of the present invention;

FIG. 5 is a flowchart showing a method for automatically switching a current SIM card to a main SIM card corresponding to at least one of an execution-requested application and execution-requested service in a dual SIM card terminal by consulting SIM card setting information when the corresponding at least one of the application execution and the service execution is requested according to an exemplary embodiment of the present invention;

FIG. 6 is a diagram showing SIM card management menus for setting a main SIM card based on at least one of a location-specific basis, a region-specific basis, and a provider-specific basis in a dual SIM card terminal by segmenting setting items for two SIM cards in a SIM card management menu according to an exemplary embodiment of the present invention;

FIG. 7 is a flowchart showing a method for setting a main SIM card based on at least one of a location-specific basis, a region-specific basis, and a /provider-specific basis in a dual SIM card terminal by segmenting setting items for two SIM cards in a SIM card management menu according to an exemplary embodiment of the present invention; and

FIG. 8 is a flowchart showing a method of automatically switching a current SIM card to a main SIM card corresponding to an adjusted at least one of location, region, and provider in a dual SIM card terminal by obtaining the corresponding at least one of location information, region information, and provider information, recognizing a change of the corresponding at least one of location, region, and provider and then consulting SIM card setting information while a user is mobile according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein may be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, exemplary embodiments of the present invention will be described with regard to a methodology of setting a main Subscriber Identity Module (SIM) card in a dual SIM card terminal. However, the present invention is not limited to a dual SIM card terminal, and may instead be expanded for use with a multiple SIM card terminal that may combine and use multiple SIM cards together.

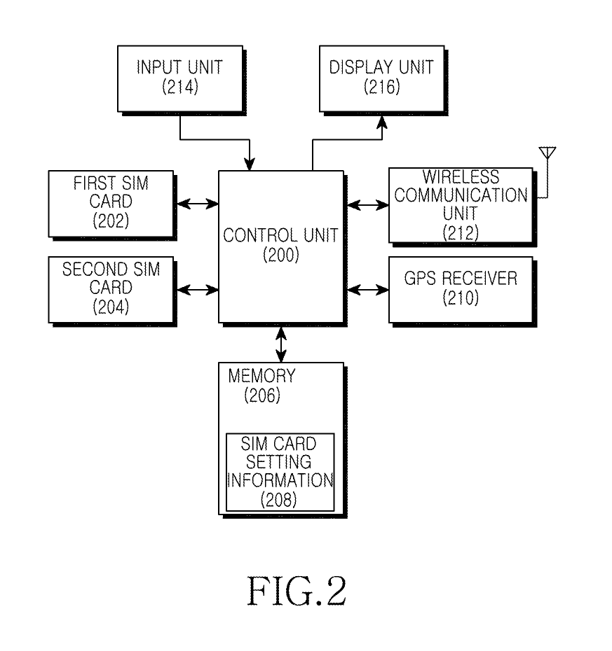

FIG. 2 is a diagram showing a construction of a dual SIM card terminal according to an exemplary embodiment of the present invention.

Referring to FIG. 2, the device may include a control unit 200, a first SIM card 202, a second SIM card 204, a memory 206, a Global Positioning System (GPS) receiver 210, a wireless communication unit 212, an input unit 214, and a display unit 216.

The control unit 200 controls general operations of the dual SIM card terminal For example, the control unit 200 performs processes and controls for at least one of a voice communication and data communication, and processes a function of switching a first SIM card 202 and a second SIM card 204 based on at least one of an application-specific basis, a service-specific basis, a location-specific basis, a region-specific basis, and a provider-specific basis according to an exemplary embodiment of the present invention in addition to a normal function. That is, pursuant to an exemplary embodiment of the present invention, the control unit 200 processes to set a main SIM card based on at least one of an application-specific basis and a service-specific basis by segmenting a setting item for two SIM cards 202, 204 in a SIM card management menu, and switch a current SIM card to a main SIM card corresponding to at least one of an execution-requested application and an execution-requested service by consulting SIM card setting information 208 stored in the memory 206 when the corresponding at least one of the application execution and the service execution is requested. Also, pursuant to another exemplary embodiment of the present invention, the control unit 200 processes to set a main SIM card based on at least one of a location-specific basis, a region-specific, and a provider-specific basis by segmenting a setting item for two SIM cards 202, 204 in a SIM card management menu, and switch a current SIM card to a main SIM card corresponding to at least one of an adjusted location, an adjusted region, an adjusted provider automatically by obtaining corresponding at least one of location, region, and provider information automatically, recognizing the corresponding at least one of location change, region change, and /provider change and consulting SIM card setting information 208 while a user is mobile.

The memory 206 stores one or more programs for one or more processes and control of the control unit 200, and stores data occurring during each program execution. More specifically, the memory 206 stores a program for switching a SIM card based on at least one of an application-specific basis, a service-specific basis, a location-specific basis, a /region-specific basis, and a provider-specific basis, and stores user-setting SIM card setting information 208 through a SIM card management menu.

The GPS receiver 210 receives user position information from a GPS satellite and provides the user position information to the control unit 200. In addition, the user position information may be obtained through various methods, for example, it may be obtained through a message broadcast from a network such as Short Message Service Cell Broadcast (SMSCB), or may also be obtained through system information transmitted via a signaling from a network, such as Network System Information.

The wireless communication unit 212 at least one of transmits and receives a wireless communication signal via an antenna. For example, the wireless communication unit 212 modulates and frequency-up converts a signal from the control unit 200 and transmits the modulated and frequency-up converted signal via an antenna, or it frequency-down converts and demodulates a wireless signal received via an antenna for provision to the control unit 200.

The input unit 214 has a one or more key buttons, such as 0˜9 number key buttons, menu buttons, a cancel button (erase), a confirm button, a calling button (TALK), an end button (END), a photographing button, an internet access button, navigation key (or direction key) buttons (▴/ [symbol] /▾/ [symbol] ), and provides key input data corresponding to a user pressed key to the control unit 200.

The display unit 216 displays status information, characters, moving images, still images, and the like, produced during an operation of the dual SIM card terminal The display unit 216 may be implemented with one of a color Liquid Crystal Display, an Organic Light-Emitting Diode (OLED), an Active-Matrix Organic Light-Emitting Diode (AMOLED), etc. If the display unit 216 is provided as a touch screen, the display unit 216 may perform a part or all of the functions of the input unit 214.

First, a methodology of setting a main SIM card based on at least one of an application-specific basis and a service-specific basis by segmenting a setting item for two SIM cards in a SIM card management menu, and automatically switching to a main SIM card based on a corresponding at least one of an execution-requested application and an execution-requested service by consulting SIM card setting information when the corresponding at least one of the application execution and the service execution is requested in a dual SIM card terminal, according to an exemplary embodiment of the invention, will be described below.

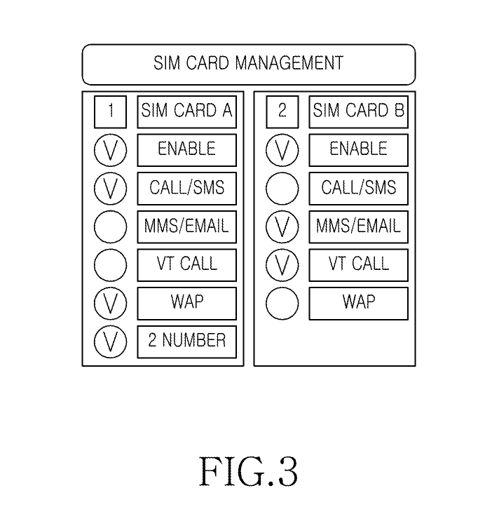

Suppose that, for instance, a dual SIM card terminal may use a SIM card from ‘A’ provider and a SIM card from ‘B’ provider in combination, where a SIM card by ‘A’ provider has low rates for voice calls, and a SIM card by ‘B’ provider has low rates for data or is contracted to provide a specific data service. In this case, through a SIM card management menu, a user may pre-configure to use the ‘A’ provider SIM card as a main SIM card for voice service, and to use the ‘B’ provider SIM card as a main SIM card for data communication services. Accordingly, the user may use a specific provider SIM card based on at least one of an application-specific basis and a service-specific basis. Herein, when only one main SIM card is set to be used per at least one of the application-specific basis and the service-specific basis as described above, it would be obvious that a simultaneous mobile communication service is possible through both of the two SIM cards, and the settings may be changed at any time. A more detailed example will be described below with reference to FIG. 3.

FIG. 3 is a diagram showing a SIM card management menu for setting a main SIM card based on at least one of an application-specific basis and a service-specific basis in a dual SIM card terminal by segmenting setting items for two SIM cards in a SIM card management menu according to an exemplary embodiment of the present invention.

Referring to FIG. 3, a user may set a main SIM card based on at least one of an application-specific basis and a service-specific basis by selecting setting items for two SIM cards through a SIM card management menu. According to an exemplary embodiment of the present invention, setting items for two SIM cards may be based on at least one of an application type and a service type. For example, the setting items may include an enable item indicating whether a selection result for following items is applied (that is, whether a corresponding SIM card is enabled), a CALL/Short Message Service (SMS) item indicating whether a corresponding SIM card is used as a default for at least one of CALLs and SMSs, a Multimedia Messaging Service (MMS)/Electronic-mail (E-mail) item indicating whether a corresponding SIM card is used as a default for at least one of MMSs and E-mails, a Video Telephone (VT) Call item indicating whether a corresponding SIM card is used as a default for VT Calls, and a Wireless Application Protocol (WAP) item indicating whether a corresponding SIM card is used as a default for WAP. Also, in a case where services are only provided by a specific provider (for example, a 2 Number service) as one type of SIM Application Toolkit (SIMAT), an item indicating whether the specific provider SIM card is to be used as a default for the specific service (for example, a 2 Number item) may further be included to the setting items.

In FIG. 3, a user sets ‘A’ SIM card as a main SIM card for Call/SMS and WAP, also SIM card ‘A’ is set as a main SIM card for 2 number service since the 2 Number service is contracted with the provider associated with SIM card ‘A’, and SIM card ‘B’ is set as a main SIM card for MMS/E-mail and VT Call. Here, the user selected the corresponding Enable item, Call/SMS item, WAP item, and 2 Number item for SIM card ‘A’, and selected the corresponding Enable item, MMS/E-mail item and VT Call item for SIM card ‘B’.

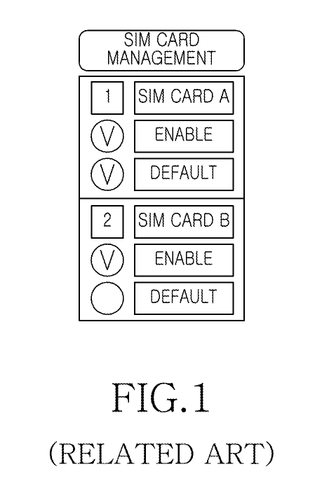

According to an exemplary embodiment, it is also possible to include one enable item as a setting item for the two SIM cards instead of including each separate enable items for the two SIM cards as a setting item. In this case, the one enable item indicates whether a selection result for following items is applied for both of the two SIM cards. According to another exemplary embodiment, in the case of a dual SIM card terminal capable of both of a SIM card setting method consistent with the related art as described with reference to FIG. 1 and a SIM card setting method according to an exemplary embodiment of the present invention as described with reference to FIG. 3, for selection of an enable item, one of the above two methods may be chosen.

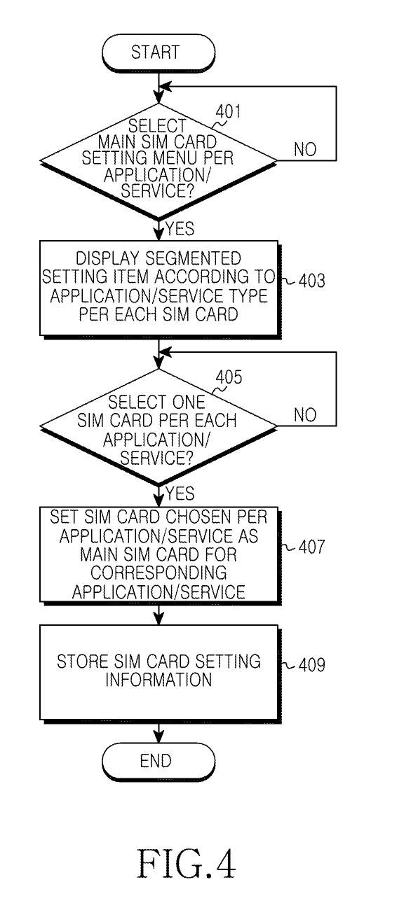

FIG. 4 is a flowchart showing a method for setting a main SIM card based on at least one of an application-specific basis and a service-specific basis in a dual SIM card terminal by segmenting setting items for two SIM cards in a SIM card management menu according to an exemplary embodiment of the present invention.

Referring to FIG. 4, a dual SIM card terminal determines if a main SIM card setting menu is selected based on at least one of an application-specific basis and a service-specific basis according to a user key manipulation in step 401. For example, the main SIM card setting menu for at least one of an application and a service may exist as a sub menu of a SIM card management menu.

When it is detected that a main SIM card setting menu based on at least one of an application-specific basis and a service-specific basis is selected in step 401, the dual SIM card terminal displays a segmented setting item according to at least one of an application type and a service type for each SIM card in step 403. For example, segmented setting items as shown in FIG. 3 may be displayed.

Thereafter, the dual SIM card terminal detects if one SIM card per each of the corresponding at least one of the application type and service type according to a user key manipulation is selected in step 405. That is, it is detected if a segmented setting item based on the corresponding at least one of the application type and the service type per each SIM card is selected.

When it is detected that one SIM card per each of the corresponding at least one of the application and the service is selected in step 405, the dual SIM card terminal sets a SIM card chosen per the corresponding at least one of the application and the service as a main SIM card for a corresponding at least one of the application and the service in step 407, and proceeding to step 409, stores SIM card setting information according to the setting in a memory. At this time, the dual SIM card terminal may generate and output a guide voice or message informing that a main SIM card per the corresponding at least one of the application and the service has been set.

Thereafter, the dual SIM card terminal ends the algorithm according to the exemplary embodiment of the present invention.

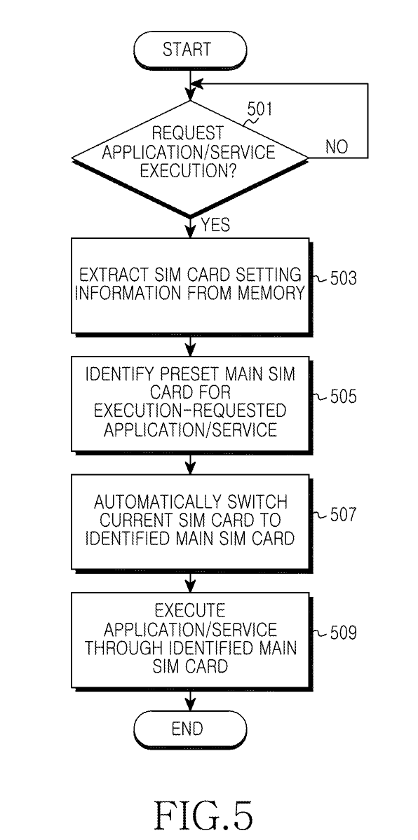

FIG. 5 is a flowchart showing a method for automatically switching a current SIM card to a main SIM card corresponding to at least one of an execution-requested application and execution-requested service in a dual SIM card terminal by consulting SIM card setting information when the corresponding at least one of the application execution and the service execution is requested according to an exemplary embodiment of the present invention.

Referring to FIG. 5, a dual SIM card terminal determines if an execution of a specific at least one of an application and a service according to a user key manipulation is requested in step 501.

In step 501, when an execution request for the specific of the at least one of the application and the service is detected, the dual SIM card terminal proceeds to step 503 and extracts SIM card setting information from a memory.

Thereafter, the dual SIM card terminal identifies a preset main SIM card for the at least one of the execution requested application and the execution requested service based on the SIM card setting information in step 505.

Thereafter, the dual SIM card terminal automatically switches a current SIM card to the identified main SIM card in step 507, and executes the at least one of the execution requested application and the execution requested service through the identified main SIM card in step 509. At this time, the dual SIM card terminal may generate and output a guide voice or message informing that a current SIM card has been automatically switched to the identified main SIM card.

Thereafter, the dual SIM card terminal ends an algorithm according to the exemplary embodiment of the present invention.

Next, a methodology for automatically setting a main SIM card based on at least one of a location-specific basis, a region-specific basis, and a provider-specific basis by segmenting setting items for two SIM cards in a SIM card management menu, and changing a current SIM card to a main SIM card corresponding to a changed at least one of a location, a region, and a provider in a dual SIM card terminal by obtaining corresponding at least one of location, region, and provider information automatically, recognizing at least one of a location change, a region change, and a provider change and then consulting SIM card setting information while a user is mobile according to an exemplary embodiment of the present invention.

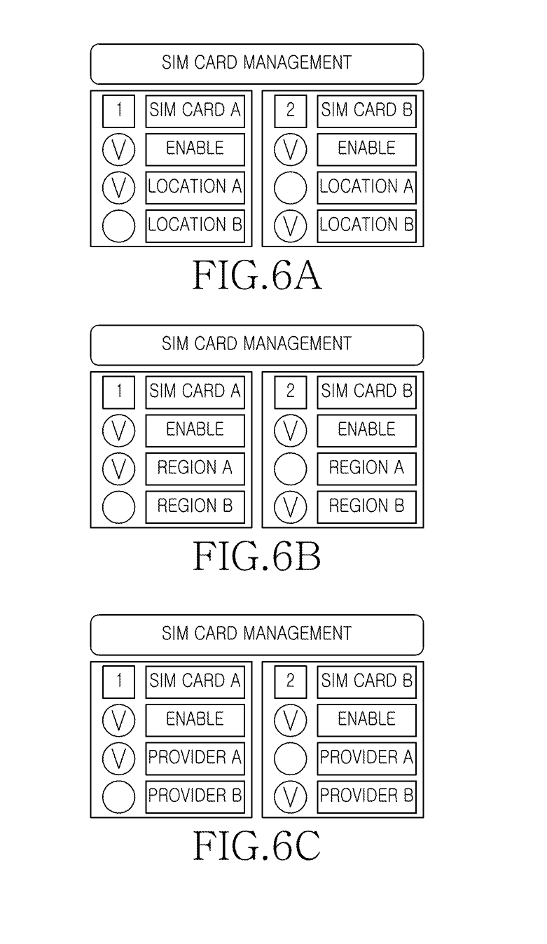

In exemplary description, it is assumed that a dual SIM card terminal uses a personal SIM card and a business SIM card in combination. In this case, a user may have previously set to use a business SIM card as a main SIM card when located at a company, and use a personal SIM card as a main SIM card when located out of the office (for example, a home), through a SIM card management menu. Therefore, the user may use a different SIM card per location. A similar method is applicable to the case of a user using several regions (for example, nations) of a SIM card because of a frequent business trip. Here, the user may pre-set a main SIM card to be used when located in each region through a SIM card management menu, and thus may use a different SIM card per each region. Also, a user may pre-set a main SIM card to be used when located in a service area of given provider through a SIM card management menu, and thus uses a different SIM card per each provider. Herein, when only one main SIM card is set to be used based on at least one of a location, a region, and a provider as described above, it would be obvious that simultaneous mobile communication is possible through both of the two SIM cards, and the settings may be changed at any time. A more detailed example will be described below with reference to FIG. 6.

FIG. 6 is a diagram showing SIM card management menus for setting a main SIM card based on at least one of a location-specific basis, a region-specific basis, and a provider-specific basis in a dual SIM card terminal by segmenting setting items for two SIM cards in a SIM card management menu according to an exemplary embodiment of the present invention. Herein, FIG. 6 includes SIM card management menu (A), SIM card management menu (B), and SIM card management menu (C).

Referring to FIG. 6, a user may set a main SIM card based on at least one of a location-specific basis, a region-specific basis, a provider-specific basis by selecting setting items for two SIM cards through a SIM card management menu. In an exemplary embodiment of the present invention, segmented setting items for two SIM cards may be based on at least one of a location, a region, and a provider. Herein, the at least one of the location, the region, and the provider to be included in the setting item may be configured as the at least one of the location, the region, and the provider previously input or selected by the user, and various exemplary embodiments are also possible.

SIM card management menu (A) shows the setting of a main SIM card per location. For example, setting items for each SIM card may include an enable item indicating whether a corresponding SIM card is enabled, a location A item indicating whether a corresponding SIM card is used as a default SIM card in an ‘A’ location (for example, an office) and a location B item indicating whether a corresponding SIM card is used as a default SIM card in a ‘B’ location (for example, a home). SIM card management menu (A) shows a case where a user sets ‘A’ SIM card as a main SIM card for location ‘A’ and sets ‘B’ SIM card as a main SIM card for location ‘B’. To do this, the user selects a corresponding enable item and location ‘A’ item for SIM card ‘A’, and selects a corresponding enable item and location ‘B’ item for SIM card ‘B’. By doing this, the user may receive a mobile communication service through ‘A’ SIM card when the user is located in location ‘A’ (for example, an office), and may receive a mobile communication service through ‘B’ SIM card when located in location ‘B’ (for example, a home).

SIM card management menu (B) shows the setting of a main SIM card per region. For example, setting items for each SIM card may include an enable item indicating whether a corresponding SIM card is enabled, a region A item indicating whether a corresponding SIM card is used as a default SIM card in ‘A’ region and a region B item indicating whether a corresponding SIM card is used as a default SIM card in ‘B’ region. SIM card management menu (B) shows a case where a user sets ‘A’ SIM card as a main SIM card for region ‘A’ and sets ‘B’ SIM card as a main SIM card for region ‘B’. To do this, the user may select a corresponding enable item and region ‘A’ item for SIM card ‘A’, and select a corresponding enable item and region ‘B’ item for SIM card ‘B’. By doing this, the user may receive a mobile communication service through ‘A’ SIM card when located in region ‘A’, and may receive a mobile communication service through ‘B’ SIM card when located in region ‘B’.

SIM card management menu (C) shows the setting of a main SIM card per provider. For example, setting items for each SIM card may include an enable item indicating whether a corresponding SIM card is enabled, a provider A item indicating whether a corresponding SIM card is used as a default SIM card over ‘A’ provider and a provider B item indicating whether a corresponding SIM card is used as a default SIM card over ‘B’ provider. SIM card management menu (C) shows a case where a user sets ‘A’ SIM card as a main SIM card for provider ‘A’ and sets ‘B’ SIM card as a main SIM card for provider ‘B’. To do this, the user may select a corresponding enable item and provider ‘A’ item for SIM card ‘A’, and select a corresponding enable item and provider ‘B’ item for SIM card ‘B’. By doing this, the user may receive a mobile communication service through ‘A’ SIM card when located in a service area of provider ‘A’, and may receive a mobile communication service through ‘B’ SIM card when located in a service area of provider ‘B’.

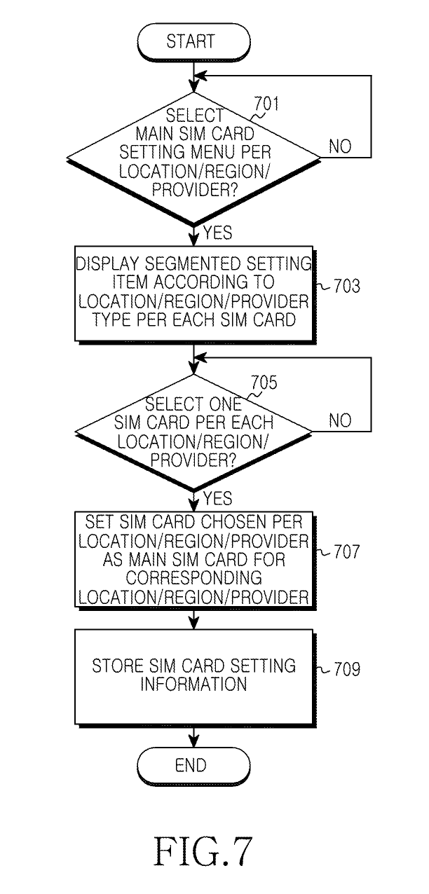

FIG. 7 is a flowchart showing a method for setting a main SIM card based on at least one of a location-specific basis, a region-specific basis, and a provider-specific basis in a dual SIM card terminal by segmenting setting items for two SIM cards in a SIM card management menu according to an exemplary embodiment of the present invention.

Referring to FIG. 7, a dual SIM card terminal determines if a main SIM card setting menu based on at least one of location, region, and provider according to a user key manipulation is chosen in step 701. For example, the main SIM card setting menu based on at least one of location, region, and provider may exist as a sub menu of a SIM card management menu.

When it is detected that a main SIM card setting menu based on at least one of location, region, and provider is selected in the step 701, the dual SIM card terminal displays a segmented setting item based on at least one of a location, a region and a provider type per each SIM card in step 703. For example, the segmented setting items as shown in FIG. 6 may be displayed.

Thereafter, the dual SIM card terminal determines if one SIM card per at least one of location, region, and provider according to a user key manipulation is selected in step 705. That is, it is detected if the segmented setting item for at least one of location, region, and provider type per each SIM card is selected.

When it is detected that one SIM card per each of at least one of a location, a region, and a provider is selected in the step 705, the dual SIM card terminal sets a SIM card selected per the at least one of the location, the region, and the provider as a main SIM card for a corresponding at least one of location, region, and provider in step 707, and proceeding to step 709, stores SIM setting information according to the setting in a memory. At this time, the dual SIM card terminal may generate and output a guide voice or message informing that a main SIM card has been established per location/region/provider.

Thereafter, the dual SIM card terminal ends the algorithm according to an exemplary embodiment of the present invention.

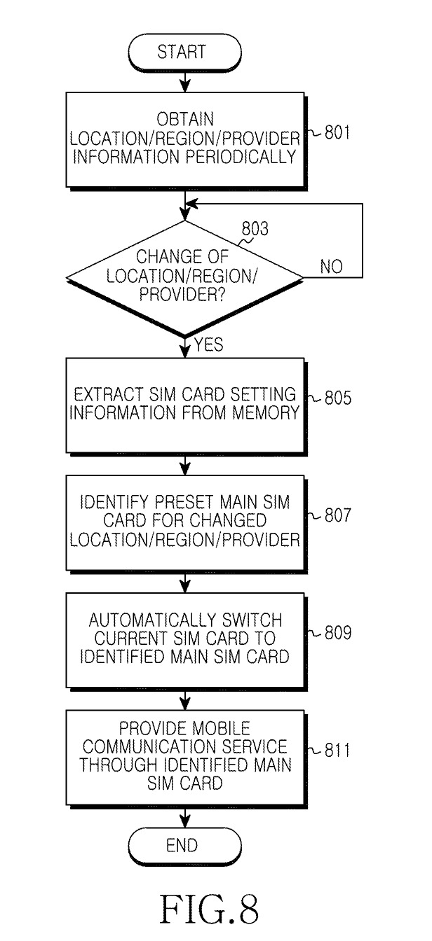

FIG. 8 is a flowchart showing a method of automatically switching a current SIM card to a main SIM card corresponding to an adjusted at least one of location, region, and provider in a dual SIM card terminal by obtaining the corresponding at least one of location information, region information, and provider information, recognizing a change of the corresponding at least one of location, region, and provider and consulting SIM card setting information while a user is mobile according to an exemplary embodiment of the present invention.

Referring to FIG. 8, a dual SIM card terminal obtains at least one of location information, region information, and provider information periodically in step 801. Herein, the at least one of the location information, region information, and provider information may be received and obtained from a GPS satellite, or may be obtained through a message broadcast from a network such as SMSCB, or also may be obtained through system information transmitted via a signaling from a network such as network system information.

Thereafter, the dual SIM card terminal determines if at least one of a location, a region, and a provider has changed based on the obtained at least one of the location information, the region information, and the provider information in step 803.

In step 803, when at least one of the location, the region, and the provider has changed, the dual SIM card terminal proceeds to step 805 and extracts SIM card setting information from a memory.

Thereafter, the dual SIM card terminal identifies a preset main SIM card for the changed at least one of the location, the region, and the provider based on the SIM card setting information in the step 807.

Thereafter, the dual SIM card terminal changes a current SIM card to the identified main SIM card automatically in step 809, and provides a mobile communication service through the identified main SIM card in step 811. At this time, the dual SIM card terminal may generate or output a guide voice or message informing that a current SIM card has been automatically changed to the identified main SIM card.

Thereafter, the dual SIM card terminal ends the algorithm according to an exemplary embodiment of the present invention.

As described above, exemplary embodiments of the present invention have the advantage of allowing a user to set a SIM card of a desired provider as a main SIM card for each of at least one of an application, a service, a location, a region, and a provider and receiving a mobile communication service through a corresponding SIM card. Herein, the user selects a main SIM card for each of at least one of an application, a service, a location, a region, and a provider by segmenting setting items for two SIM cards in a SIM card management menu and setting a main SIM card based on at least one of the application, the service, the location, the region, and the provider in a dual SIM card terminal. That is, a main SIM card is automatically changed based on at least one of the application, the service, the location, the region, and the provider. Therefore, the user may automatically receive a mobile communication service of a desired provider for each of at least one of an application, a service, a location, a region, and a provider without changing the settings of a SIM card manually through a direct menu manipulation whenever the user desires to receive a mobile communication service through a different SIM card based on at least one of an application, a service, a location, a region, and a provider, and thus the exemplary embodiments of the present invention has the advantage of providing user convenience and functionality.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of setting a main Subscriber Identity Module (SIM) card in a multiple SIM card terminal, the method comprising:
displaying a segmented setting item according to a service type per each SIM card when a main SIM card setting menu is selected; and
setting a SIM card selected per the service type as a main SIM card for the corresponding service type when one SIM card per each service type is selected.

2. The method of claim 1, further comprising displaying one enable item for selecting multiple SIM cards according to the service type when the main SIM card setting menu is selected.

3. The method of claim 1, wherein the main SIM card setting menu is a sub menu of a SIM card management menu.

4. The method of claim 1, further comprising storing SIM card setting information, according to the setting, in a memory.

5. The method of claim 4, further comprising:
extracting SIM card setting information from the memory when a specific service execution is requested;
identifying a preset main SIM card for the specific service based on the SIM card setting information; and
automatically switching a current SIM card to the identified main SIM card.

6. The method of claim 1, wherein the each SIM card-specific setting item is segmented according to at least one of the service type, an application type, a location type, a region type and a provider type.

7. The method of claim 6, further comprising:
storing SIM card setting information, according to the setting, in a memory;
extracting SIM card setting information from the memory, when it is determined that at least one of location, region and provider has been changed;
identifying a preset main SIM card for at least one of the changed location, region and provider based on the SIM card setting information; and
automatically switching a current SIM card to the identified main SIM card.

8. The method of claim 7, further comprising:
obtaining location information periodically; and
identifying if at least one of the location, the region and the provider is changed based on the obtained location information.

9. The method of claim 8, wherein the location information is at least one of obtained from a Global Positioning System (GPS) receiver, obtained through a message broadcast from a network, and obtained through system information transmitted via a signaling from a network.

10. An apparatus for setting a main Subscriber Identity Module (SIM) card in a multiple SIM card terminal, the apparatus comprising:
a control unit for controlling to display a segmented setting item according to a service type per each SIM card on a display unit when a main SIM card setting menu is selected and for setting a selected SIM card for the service type as a main SIM card for the corresponding service type when one SIM card per each service type is selected through an input unit;
the display unit for displaying the segmented setting item according to the service type per each SIM card; and
the input unit for receiving the selection of one SIM card per each service.

11. The apparatus of claim 10, wherein the control unit controls to display one enable item for selecting multiple SIM cards according to the service type when the main SIM card setting menu is selected.

12. The apparatus of claim 10, wherein the main SIM card setting menu is a sub menu of a SIM card management menu.

13. The apparatus of claim 10, further comprising a memory for storing SIM card setting information according to the setting.

14. The apparatus of claim 13, wherein the control unit extracts SIM card setting information from the memory when a specific service execution is requested, identifies a preset main SIM card for the specific service based on the SIM card setting information, and automatically switches a current SIM card to the identified main SIM card.

15. The apparatus of claim 10, wherein each SIM card-specific setting item is segmented according to at least one of the service type, an application type, a location type, a region type and a provider type.

16. The apparatus of claim 15, further comprising a memory for storing SIM card setting information according to the setting,
wherein the control unit extracts SIM card setting information from the memory, when it is determined that at least one of location, region and provider has been changed, identifies a preset main SIM card for at least one of the changed location, region and provider based on the SIM card setting information, and automatically switches a current SIM card to the identified main SIM card.

17. The apparatus of claim 16, further comprising a Global Positioning System (GPS) receiver for obtaining location information periodically,
wherein the control unit identifies if at least one of the location, the region and the provider is changed based on the obtained location information.

18. The apparatus of claim 17, wherein the location information is received from at least one of a GPS satellite, a message broadcast from a network, and system information transmitted via a signaling from a network.
